(19) United States
(12) Patent Application Publication
(10) Pub. No.: US 2001/0037359 A1
(43) Pub. Date: Nov. 1, 2001

(54) System and method for a server-side browser including markup language graphical user interface, dynamic markup language rewriter engine and profile engine

(76) Inventors: Gregory P. Mockett, Spanish Fork, UT (US); David Wingate, Provo, UT (US)

Correspondence Address: TRASK BRITT, P.O. BOX 2550, SALT LAKE CITY, UT, 84110, US

(21) Appl. No.: 09/777,728

(22) Filed: Feb. 5, 2001

Related U.S. Application Data
(60) Provisional application No. 60/180,458, filed on Feb. 4, 2000.

(51) Int. Cl. G06F 15/16; G06F 15/00; G06F 17/00

(52) U.S. Cl. 709/203; 345/747; 709/246; 709/217; 707/513

(57) ABSTRACT

The invention is a system and method for customizing access and delivery of information distributed in a packet-based network. The system includes a user computer and a destination server computer separated by a server-side browser (SSB) server computer hosting a SSB. The SSB includes a markup language graphical user interface (MLGUI), a dynamic markup language rewriter engine (DMLRE) and a profiling engine (PE). The SSB may be configured as an intermediary infrastructure residing on the Internet providing customized information gathering for a user. The components of the SSB allow for controlling, brokering and distributing information more perfectly by controlling both browser functionality (on the client-side) and server functionality (on the destination site side) within a single point and without the necessity of incremental consents or integration of either side.

### PRIORITY CLAIM

This patent application claims the benefit of the filing date of United States Provisional Patent Application Ser. No. 60/180,458, filed Feb. 4, 2000, for “SYSTEM AND FEATURES OF A COMBINATION SERVER SIDE BROWSER, DYNAMIC WEB PAGE REWRITER ENGINE AND PROFILE ENGINE”, the disclosure of which is incorporated herein by reference for all purposes. This patent application is related to copending utility patent application for “SYSTEM AND METHOD FOR DYNAMICALLY ISSUING AND PROCESSING TRANSACTION SPECIFIC DIGITAL CREDIT OR DEBIT CARDS”, filed Feb. 5, 2001, attorney docket number, 2741-4279.1US, the disclosure of which is incorporated herein by reference for all purposes.

### TECHNICAL FIELD

The invention relates generally to Internet web browsers and more specifically to an intermediary infrastructure for gathering, filtering and presenting information from the Internet to a user.

### BACKGROUND ART

The explosive increase in web content and the tide of commercialism sets the stage for a difficult consumer proposition in managing disclosures and other web related information. The paradox is that privacy, which requires non-disclosure and personalization of content and information, which requires disclosure are diametrically opposed and present an increasing proliferation of trust propositions for consumers to negotiate. Thus, it is desirable to have a system with software that allows customized information gathering and delivery or presentation to the user.

FIG. 1 illustrates a block diagram of a conventional system 100 for a user interacting with the Internet 102. The terms “Internet” and “Web” are used interchangeably herein. System 100 includes a user computer 104 configured for Internet connection, having a client-side browser (CSB) 106 installed thereon. A user operating user computer 104 and CSB 106 may connect to the Internet 102, perhaps through an Internet service provider (ISP) 108 (shown with dotted lines to indicate optional). The Internet connection may be over telephone lines through a modem to an ISP 108, a digital subscriber line (DSL) connection, a cable modem connection, a T-1 line connection, or any other conventional means for effecting an Internet connection. The CSB 106 may be, for example and not by way of limitation, Internet Explorer™ from Microsoft Corporation, Redmond, Wash., or any other Internet Web-based browser, that allows users to view and interact with Web pages on the Internet. Using the CSB 106, the user may access Web pages 110 by the address appellation for same located on destination server computers 112.

However, there is a need in the art for a single system and method for addressing consumer issues, such as filtering by content attributes, previewing link content, privatizing online activities, improving mobility, preventing fraud, making e-commerce anonymous, that are not addressed in the prior art.

### DISCLOSURE OF INVENTION

The invention is a system and method for a server-side browser including markup language graphical user interface (MLGUI), dynamic markup language rewriter engine (DMLRE) and profile engine (PE).

In accordance with the present invention, a system for providing a user customized access to information distributed over a packet-based network includes a user computer including a client-side browser (CSB) configured for communication over the packet-based network and a destination server computer configured for communication over the packet-based network and wherein the destination server computer contains the information. The system further includes an intermediary server configured for communication over the packet-based network positioned between the user computer and the destination computer, wherein the intermediary server computer comprises a server-side browser (SSB) configured for filtering information transmitted between the user computer and the destination server computer in accordance with a user's preferences.

A SSB server computer configured for Internet connection for facilitating customized access to information distributed over a packet-based network, is disclosed including a bidirectional gateway between a user computer and destination server computer and a SSB controlling said bidirectional gateway.

A method for accessing customized information from an Internet is disclosed including logging into a SSB, requesting information from a Web site on the Internet through the SSB, the SSB receiving the requested information and rewriting the information from the Web site and displaying the rewritten information in the SSB.

Another system for providing a user customized access to information distributed over a packet-based network is disclosed including a user computer hosting a CSB for viewing markup language documents and multimedia files, executing Applets and plug-in files distributed over the packet-based network. The system further includes a SSB server computer configured to communicate with the user computer over the packet-based network, said SSB server computer hosting a SSB.

These embodiments and methods of the present invention will be readily understood by reading the following detailed description in conjunction with the accompanying figures of the drawings.

### BRIEF DESCRIPTION OF DRAWINGS

In the drawings, which illustrate what is currently regarded as the best mode for carrying out the invention and in which like reference numerals refer to like parts in different views or embodiments:

FIG. 1 is a block diagram of a conventional system for gathering information and viewing Web pages on the Internet.

FIG. 2 is a block diagram of a system incorporating the server-side browser (SSB) of the present invention.

FIG. 3 is an expanded block diagram of an SSB in accordance with the present invention.

FIG. 4 is a flow diagram of a method of accessing customized information from the Internet in accordance with the present invention.

### BEST MODES FOR CARRYING OUT THE INVENTION

A system and method for delivering customized information to a user from a packet-based network, such as the Internet, is disclosed. While the preferred embodiments of the present invention will be described with reference to their application on the Internet, it should readily be recognized that the invention may be applied in the context of any packet-based network where information is distributed across the network. The terms “static information delivery” and “Web page” are used synonymously herein.

The present invention is an intermediary infrastructure on the Internet including a unique combination of a markup language graphical user interface (MLGUI), a dynamic markup language rewriter engine (DMLRE) and a profiling engine (PE) to form a server-side browser (SSB) that may be used to control, broker, customize and distribute information transmitted and received by a user over the Internet. The present invention is configured to operate on an open network, such as the Internet and the World Wide Web, where a user will operate a user computer with a client-side browser (CSB) software application installed and operating on the user computer. The SSB acts as a bidirectional gateway between the user computer and all other destination servers on the Internet. The MLGUI may be Web-based browser, as in the preferred embodiment, that has substantially the same functionality as the user's CSB. The MLGUI utilizes the user's CSB for markup language, scripting language and applet and plug-in parsers and interpreters. The MLGUI uses the SSB infrastructure for additional functionality, not provided in the user's CSB.

The entity controlling the SSB 202 and other aspects and features of the present invention can address many of the consumer issues or problems outlined above. Additionally, such problems may be addressed dynamically without downloads, configurations, or other user interaction. The integration benefits are especially enhanced when combined with other components of the SSB 202 described below, which may also be part of the same server and database infrastructure, i.e., the intermediary server computer.

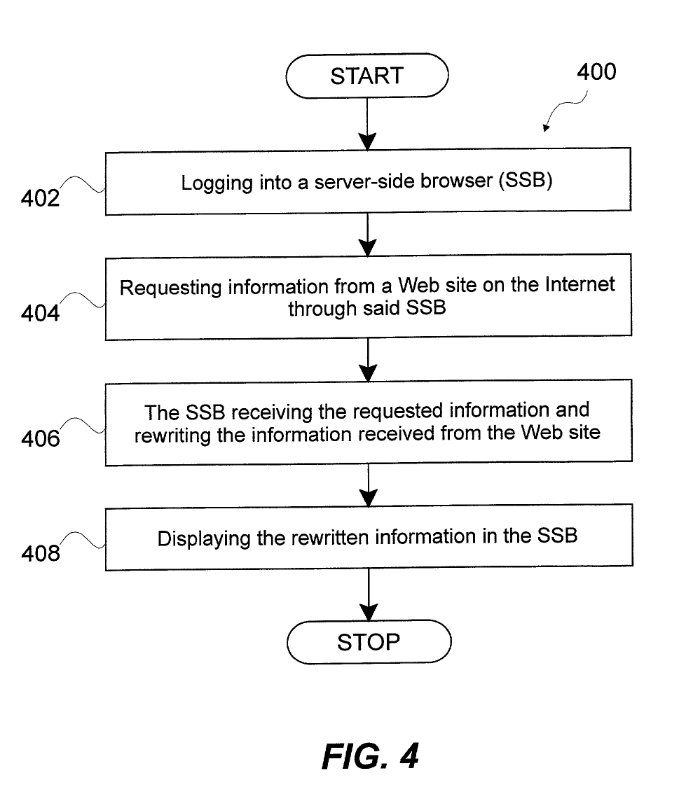

FIG. 4 illustrates a method 400 for accessing customized information from the Internet. Method 400 includes logging 402 into a SSB, requesting 404 information from a Web site on the Internet through the SSB, the SSB receiving the requested information and rewriting the information from the Web site, and displaying the rewritten information in the SSB. A user initiates method 400 of the present invention by addressing the SSB through a CSB. When addressed, the SSB asks the CSB to open a window without tools (i.e., pull-down menus, buttons for navigating forward, backward, stopping, refreshing, address bars, etc.) where the MLGUI is then loaded along with MLGUI replacement tools. One effect of the present invention is to prevent the user from connecting to one or more destination servers directly. Instead the user is allowed to connect to multiple destination servers indirectly through the SSB site. All other destination server content is then retrieved, regulated and rewritten by the DMLRE to be displayed in the MLGUI of the SSB. Additional features are provided through the PE and various Value Filters (VF) and the DMLRE to provide content that specifically meets the needs of the individual user.

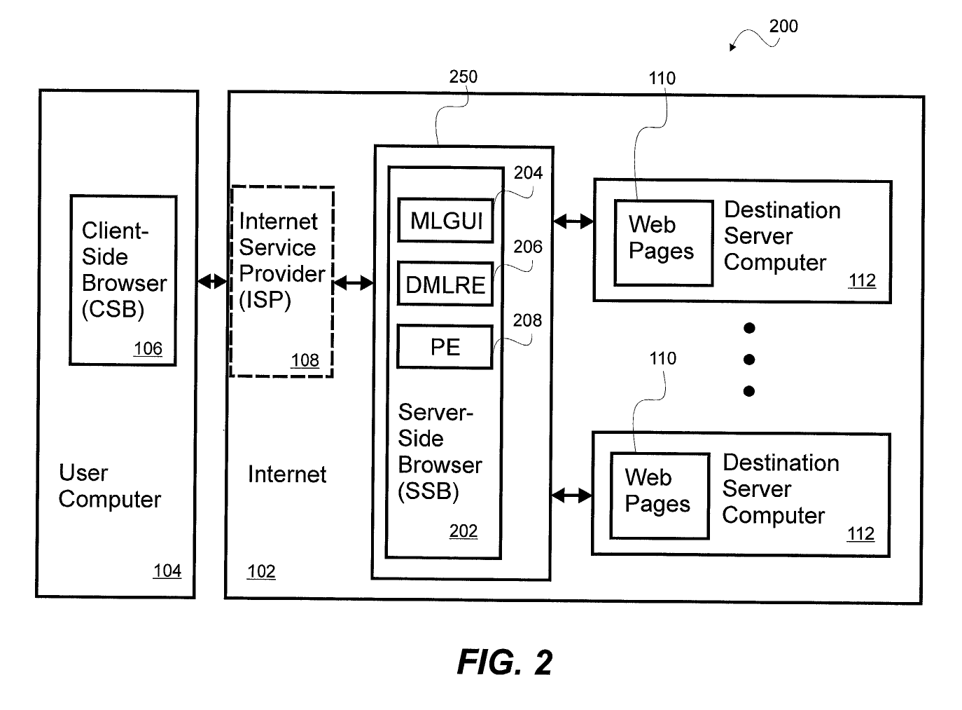

Referring to FIG. 2, a system 200 in accordance with the present invention is shown. System 200 may include one or more user computers 104 (only one shown), an optional Internet Service Provider (ISP) 108, an SSB server computer 250 and one or more destination server computers 112 (two shown).

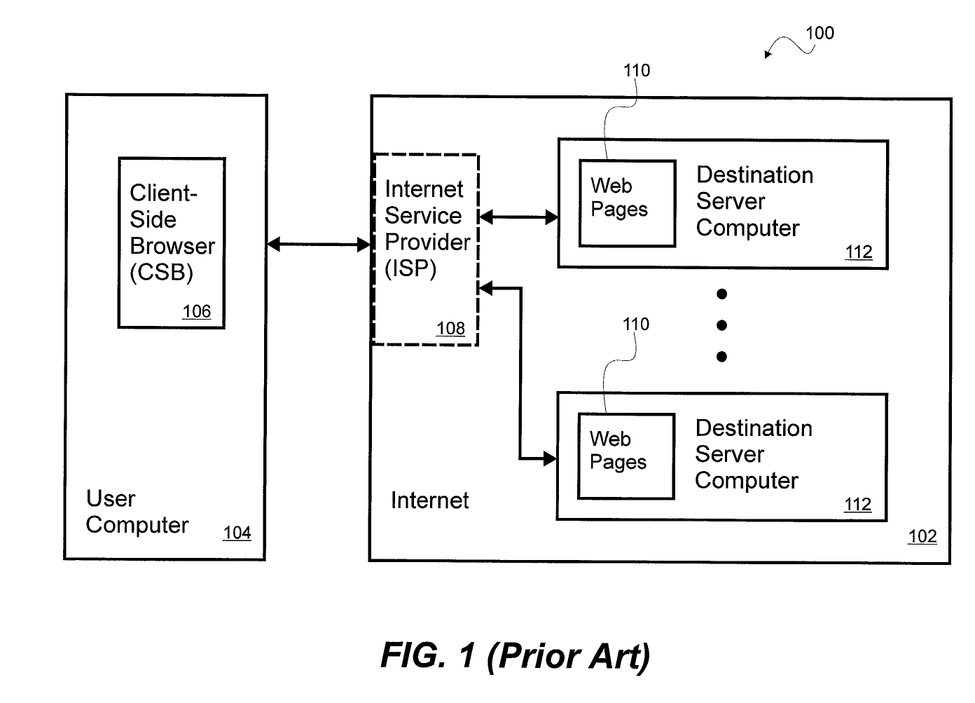

User computer 104 may have an input device, an output device, a processor, memory for storing data and computer programs, and memory for mass storage, such as a conventional personal computer (PC). User computer 104 also has a CSB 106 installed and a means for communicating with the Internet 102 as described above with regard to FIG. 1. User computer 104 is configured to run a CSB 106, which is a software application for viewing hypertext markup language (HTML) formatted documents and various software programs or “Applets”, multimedia files and other plug-in files that may be distributed through the Internet.

SSB server computer 250 may be any kind of computer configured for communicating on the Internet 102 and suitable for hosting a Web site and running software applications such as the SSB 202 of the present invention. The SSB server computer 250 includes a server-side browser (SSB) 202 which is positioned in between the user computer 104 and destination server computers 112. The SSB server computer 250 is configured to generate a MLGUI 204 for display on a standard CSB, more specifically the user computer 104 CSB 106. SSB server computer 250 is configured to transfer information between a user computer 104 and various destination computers 112.

MLGUI 204 may be configured with a “find” feature that has a user input interface within a Web page that accepts user queries to locate, mark and highlight certain user input text strings or tags. A “find” feature may be automatically activated on every Web page subsequently displayed within the MLGUI 204 until the user turns such automatic finding off. The “find” feature may be configure such that the search query is automatically retrieved from input form elements of various Web pages either by a DMLRE 206 or the MLGUI 204 and then is used within a DMLRE 206 to change future static Web pages or within the MLGUI 204 scripting code to mark any occurrences of the query as they appear in Web pages. For example, and not by way of limitation, the user may input a search string into a Web search engine and have the searched for key words highlighted in resulting pages, automatically, even at Web sites outside the search engine results.

A presently preferred embodiment of the SSB 202 is a web site that is built in a frame set. One of the frames contains a number of traditional tools similar to a standard browser application. Pull-down menus, address bars, and the like are all mimicked using HTML and scripts. Alternatively, the pull-down menus, address bars, etc. may be implemented with an Applet or some combination of Applets, HTML and script.

A second frame contains the destination server sites content such that it visually appears as it would in a normal CSB. SSB server computer 250 distributes MLGUI 204 to the user computer 104 through the core engine of the CSB 106 (therein residing and operating) and also requires a considerable amount of database functionality to track histories, bookmarks, searches, cookies, etc. associated with the user' activities. These are the functions which would occur normally at the CSB 106. Another aspect of the SSB 202 is that the CSB tool bars are removed. Therefore the only way to interact with the content frame is using the keyboard, a mouse and SSB 202 tool bars. This affords a lot of control to the entity owning and operating the SSB 202.

An additional feature of SSB 202 may include a “link preview” allowing a user to preview a Web page 110 without requiring the user having to activate a hyper link. For example, and not by way of limitation, a Web page 110 from a destination server computer 112 displayed in the SSB 202 may have an attached set of data that describe the content of a page that may be linked. The user may preview the link with an activation process (e.g., a mouse hover or mouse click) to view the attached set of data on the user computer. The link preview feature allows the SSB 202 to identify a particular link as unique based on: (1) unique tags placed in the markup language and or scripting code to delineate each aforementioned address, whether by a DMLRE 206 or a destination server computer 112, or (2) any coding within the CSB 106 resident on the user computer 104 that would allow the native tagging form to uniquely identify links for this purpose and relate each to a corresponding database of link data held residing on the user computer or on some other computer attached to the distributed network. The link preview feature may use a user's profiling data where a distance and correlation metrics algorithm is applied to determine rating or survey data relevance to the user. Such distance and correlation metrics algorithms are known to one of ordinary skill in the art, and thus, will not be further detailed herein.

The link preview might contain any or all of the following link data: (1) link survey data encompassing all objective data gatherable by SSB 202, gatherable by a user or submitted by the destination server computer 112. For example, and not by way of limitation, link survey data might include a file refresh date, universal resource locator (URL), domain owner, file size, average download speed, link quality, content attributes. Content attributes may include language of text, whether or not sexually explicit, nudity, fraud, offers, commercial, academic, etc., and (2) link rating data which encompasses all subjective data gatherable by SSB 202, data gathered by a user or submitted by the destination server computer 112. For example, and not by way of limitation, link rating data may include how informative, entertaining, offensive or useful the content was to a user.

The ISP 108, SSB server computer 250 and destination server computers 112 all communicate through the Internet 102 using transmission control protocol/Internet protocol (TCP/IP) or some derivative thereof. The SSB 202 includes a markup language graphical user interface (MLGUI) 204, a dynamic markup language rewriter engine (DMLRE) 206 and a profiling engine (PE) 208. The SSB 202 may emulate the browser functions of a standard CSB 106, but with added functionality. The SSB 202 of the present invention is a software application relying on a combination of CSB application utilities, server-side utilities, server-side computer functions, a server-side database. CSB application utilities may include parsers and interpreters located on the user computer 104, whether in hardware or software.

The server-side utilities, whether in hardware or software, may include data storage, Web pages using a markup language (such as HTML, and/or scripting code, such as scripting, and/or Applets). The server side database, may be located on the SSB server computer 250 (or located on other networked server computers attached thereto) is used to store and retrieve data specific to the user's network experience, user identification, destination sites, preferred value filter (VF) information, and the like. Additionally, the MLGUI 204, DMLRE 206 and PE 208 (collectively referred to as “the SSB 202 subsystems”) may be hosted on one or more separate server computers networked together to perform the function of the SSB 202. For example, DMLRE 206 may be located on the SSB server computer 250 or another server computer. Each of the SSB 202 subsystems is explained in greater detail below.

The system 200 of the present invention may operate in any packet-based, distributed network 102 of independent computers capable of sending and receiving information in connection with other computers in the network. The Internet is a presently preferred embodiment of such a packet-based, distributed network. While there may be a plurality of user computers 104 in system 200, there must be at least one user computer 104 in the system 200. Similarly, in system 200, there must be at least one SSB server computer 250 and at least one destination server computer 112.

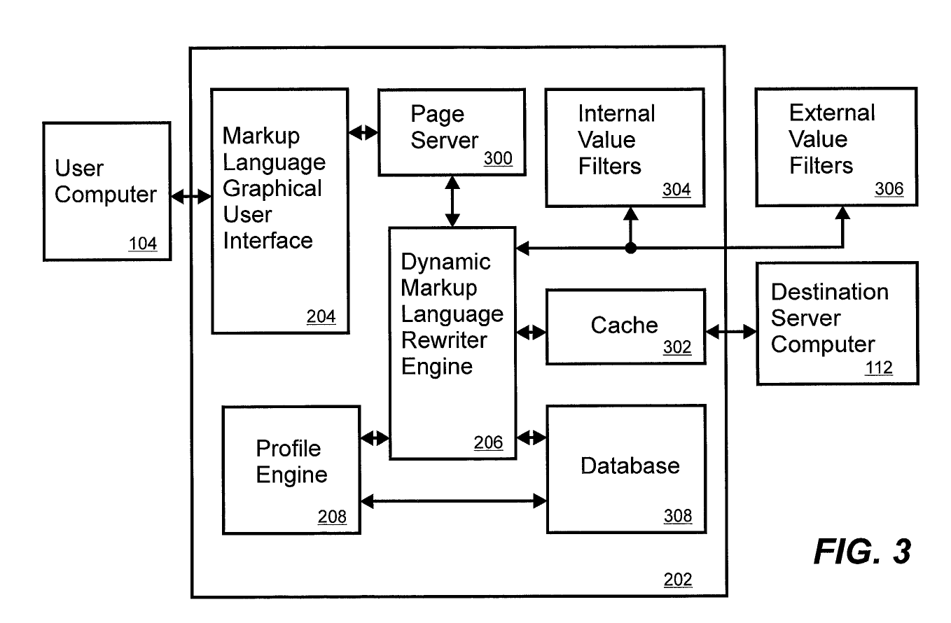

Referring to FIG. 3, an expanded block diagram of an SSB 202, in accordance with the present invention, is shown. As shown in FIG. 3, SSB 202 includes MLGUI 204, connected to page server 300, in turn connected to DMLRE 206, in turn connected to PE 208. Database 308 is connected to PE 208 and DMLRE 206. Cache 302 is connected between DMLRE 206 and destination server computer 112. Additionally, internal value filters 304 and external value filters 306 are both connected to DMLRE 206.

In accordance with the present invention, DMLRE 206 is configured to receive information in the form of markup language, scripting code, applets, files and other data objects embedded within Web pages 110 from destination server computers 112 connected to the Internet. DMLRE 206 within SSB 202 operates as a bidirectional gateway, receiving, analyzing and possibly rewriting markup language, text strings, files or other data items that may have been impacted or input by a user before communicating the possibly rewritten content back to the destination server computer 112. DMLRE 206 may reference various databases located on, or attached to, SSB server computer 250, including VF and other utilities. DMLRE 206 may be configured to rewrite or add to the received information (or “content”) for new purposes in accordance with the SSB 202. Rewritten information from the DMLRE 206 is formatted for display within the MLGUI 206.

DMLRE 206 may be configured to rewrite content for the purpose of trapping the display of the same within the MLGUI 204. Alternatively, DMLRE 206 may be configured to rewrite content for the purpose of allowing the MLGUI 204 to understand the displayed content in relation to various SSB 202 functions or controls resident therein. DMLRE 206 may be configured to consult a VF for rules and necessary libraries or data sets required by the particular value provided by the VF. A presently preferred embodiment involves text language translation and web page images removal or replacement to facilitate screening of objectionable content per the user's values.

DMLRE 206 may be configured to fill in various form elements and data entry forms within static information displays (Web pages 110) and submit them on behalf of the user without displaying such form elements and data entry forms to the user in the MLGUI 204. For example, a presently preferred embodiment involves filling in and sending a user's username and password on a login Web page 110 before it is displayed to the user, thereby appearing to conduct the user directly through to the logged in content. Alternatively, DMLRE 206 may be configured such that the filled in form elements and data entry forms within a static information delivery are displayed to the user for action.

DMLRE 206 may be configured to include links, input boxes and other markup language formatted elements, for example and not by way of limitation, tables, pages, rows, cells, columns, paragraphs, frames, graphics and words, encapsulated in invisible tags which would be ignored by the CSB 106 display. Script is the presently preferred method of encapsulating such markup language formatted elements in invisible tags. These encapsulated invisible tags allow the MLGUI 204 when combined with an SSB server computer 250 and/or with a database to provide additional functionality.

Such additional functionality may include capturing of additional information about the user's surfing experience, demographics, buying habits, psychographics, capturing user input to define static information displays in a machine readable format or to “teach” the DMLRE 206 to understand the static data it is processing such that more relevant information may be obtained about the user's surfing experience and/or used in other processes. Such additional functionality may also include filling forms using pop-up dialogs unique to each “known” form element in a static information delivery where input is required of the user and where the user might select input from said pop-up or other input methods and the selected input would then be filled into the form.

Such additional functionality may further include deleting of content where the content may be judged based on certain user specified rules and conditions as objectionable. DMLRE 206 may also be configured to provide additional functionality including reordering links, images, search results or other Web objects according to a consultation with the PE 208 and its record of links and users and ratings for display within the MLGUI 204.

Such additional functionality may also include replacing or overriding highly localized input functions of a CSB 106 in favor of functions determined by the SSB 202 on the SSB server computer 250. DMLRE 206 may also be configured to provide additional functionality including modifying the content in a highly localized way such that certain elements of the static information display may be, for example and not by way of limitation, highlighted, replaced or blacked out.

An example of the functions performed by the DMLRE 206 may include receiving a request originating from a user, on user computer 104, for a page download from a destination server computer 112. Rather than merely passing the Web page content directly to the MLGUI 204 content frame unchanged, the DMLRE 206 first rewrites the content. More specifically, the DMLRE 206 receives the HTML coded Web page with a script, etc., reads it, parses it, and then recodes the Web page using the same tools (HTML, Java™ script, etc.) but with specific changes to effect SSB controls for various new features. Such SSB controls and features include, for example and not by way of limitation, a link preview window, combination human-machine learning, value filtering and content rating. An embodiment of such SSB controls and features is achieved by embedding new Java™ script in tags that will be unreadable by conventional browsers (i.e., ignored by CSB 106), but will represent a system of interactive points where MLGUI 204 can understand or interact at various points within a static HTML document.

DMLRE 206 is also configured to rewrite the URL associated with the visual links such that the intermediary's URL or domain name address is placed on every link, which forces all future linked content through the DMLRE 206. The rewriting process performed by the DMLRE 206 puts an intermediary located at the SSB server computer in a position to learn, understand and interact at a machine level with the Internet content originally produced by the destination server computer 112 that is being sent from the user at user computer 104. The DMLRE 206 also works in the other direction. For example, where certain inputs from a user may be placed into input fields within a Web page 110 originating from a destination server computer 112, but before that input is allowed to go to the destination server computer 112, that input can be viewed, analyzed, translated, passed upon and deleted by the DMLRE 206 to effect specific functionality within the SSB 202.

A PE 208 in accordance with the present invention may include a user computer 104 connected to a distributed network, such as the Internet 102, and displaying survey forms, polls, or other question and answer interfaces using a static information delivery (such as a Web page 110) within a CSB 106 or within the MLGUI 204. Thus, a PE 208 allows the user to input, directly or indirectly, various profile data that is subsequently communicated back to an SSB 202 at an SSB server computer 250 in the presently preferred embodiment. Alternatively, the various profile data is stored locally on the user computer for communication to a DLMRE 206 or destination server computer 112 over a distributed network (i.e., Internet 102).

A user computer 104 connected to the Internet 102 provides a PE 208 with the capability to track the user's entire network browsing experience and to communicate such additional profile data and information back to the SSB 202 at the SSB server computer 250 through the Internet 102. Alternatively, a PE 208 in accordance with the present invention may be configured to extract a user's browsing experience as it passes through the DMLRE 206 or some other subsystem of the SSB 202 or server computer on which the subsystem is hosted. Profile data may be stored on a database on an SSB server computer 250, or alternatively, on a database server connected to the SSB server computer 250. Profile data may then be referenced, indexed and/or retrieved from the database.

PE 208 includes a computer process, whether in software or hardware, that analyzes the profile data stored in the database on the SSB server computer 250. Optionally, the computer process included in PE 208 may analyze other data sets or databases for various informational purposes (i.e., value filters) associated with delivering value-added performances to computers on the distributed network (i e., destination server computers, user computers, etc.) and/or the MLGUI 204, DMLRE 206, or the PE 208 itself. PE 208 may also include a database utility that separates or distinguishes identifying data or that data which would reveal the identity of or provide access to a user from personal descriptive data or that data which describes the user. PE 208 may be configured to allow destination server computers 112 free access to profile data or alternatively, for a fee.

The profile data stored in the database may be composed of sub profile data or category attributes that may be separately considered, analyzed and requested by the PE 208 within the distributed network. Such category attributes may allow for a dynamic defining of a specific or desired group or profile. Such category attributes may also allow separating each data item into value categories or alternatively assigning a value to each data item within the profile data or sub profile data for faster access or establishing relationships. PE 208 may also be configured to distribute more than one key code where a primary key code will allow the destination site to request profile data from the SSB server computer 250 regarding the user, and a secondary key code will apply to other relevant involved personae. By way of example and not as a limitation, access to two profiles might be used to reveal to a destination server computer 112 both the shopper and the individual the user is shopping for.

PE 208 may be configured to profile users, content, publishers and other Web connected components or entities, whether organic or inorganic, whether dynamic or static, with the same criterion. By using the same criterion for all profiling, greater analytical correlation of otherwise unrelated components of the network is possible. A profile data request received by PE 208 from a destination server computer 112 may request the whole profile, certain sub profiles, or individual data items. PE 208 may be configured to compare a user's profile data against other users' profile data in a process that insures that there is some minimum number of profiled users, such that the anonymous profile data disclosure is assured to not reveal enough information that could be used to identify the user or offer access to the user

PE 208 is configured to receive and manage data that is both explicitly and implicitly provided to it from a user interface. What the user did not click on in a displayed Web page can be just as important as what the user did click on. The presently preferred user interface is the MLGUI 204. In accordance with the present invention, users have direct access to and control over certain user specific profile data and certain distributions of profile data. User access and control through the PE 206 is facilitated by the MLGUI 204. PE 208 may record virtually every interaction that a user has with Web content via the DMLRE 206 and via the SSB 202 and the MLGUI 204. The SSB 202 may provide the user access to various explicit data collections by simply presenting a Web-based question or survey to the user and processing the results back to the database. The database and scripts may be used to massage the requested data. PE 208 may be used to pass data and information to destination server computers 112 allowing them to modify their content, i.e., product offerings, advertisements, etc. Profile data may be distributed in a “per request” format or a “subscription” format to destination server computers 112.

SSB server computer 250 and/or PE 208 may be configured to consider the impact of disclosing profile data in relation to a user's previous account/login with a particular destination server computer 112, a site cookie, a cross-domain cookie, or some form entry disclosures that might result in an anonymous profile disclosure being matched up with identifying or contact data. Such configured SSB server computer 250 and/or PE 208 may then be configured to block either the profile data disclosure or identifying data.

FIG. 3 illustrates a flow chart of a method 300 for accessing and distributing user profile data stored in a database over a distributed network in accordance with the present invention. Method 300 includes providing a user computer with a CSB and configured for Internet access and providing a SSB 202 on an intermediary server computer 250 configured for Internet connection. Method 300 may further include logging into the SSB through the CSB. Logging into the SSB may be accomplished through a user verification process including a password, an identification (ID) card, ID software, ID hardware key, or any other suitable method for identifying a user of the SSB 202. Such a user verification process may include a randomly reissued question from the user's profile or sub profile where the PE 208 already has an answer from the user and where the user has previously been determined from the initial login process and where the user provides a new answer to the understood question and the new result is compared to the formerly known answer(s).

Method 300 may further include generating a key code that identifies the profile data related to the user who has logged in. The key code may be generated at the user computer 104, but preferably at the SSB server computer 250. The key code may be of any length or composition. The key code may be generated randomly and does not communicate any profile data. Furthermore, the key code may be specific to a page, page request or surfing session or intra-site session. Method 300 may also include distributing the key code to destination server computers 112. Distributing the key code may be accomplished by the SSB server computer through the DMLRE 206. Alternatively, distributing the key code may be accomplished by the user computer 104 by inclusion in the HTTP Header Request. Inclusion of data in an HTTP Header Request is know to one of ordinary skill in the art, and thus, will not be further elaborated herein.

Method 300 may further includes receiving the distributed key code at a destination server computer 112 and processing the key code at the destination server computer 112. A destination server computer 112 may be configured to recognize a distributed key code because it offers access to profile data about a user. Method 300 may further includes registering the destination server computer 112 with the SSB server computer. This registering may occur prior to distribution of the key code and allows the SSB server computer and its controlling entity to identify the particular registered destination server computer 112 and its controlling entity. Method 300 may also include assigning a unique registration ID based on security parameters, if any, to the destination server computer 112. Method 300 may also assign a unique customer ID to the destination server computer's controlling entity. The destination server computers controlling entity may, for example and not by way of limitation, be an e-commerce vendor.

Method 300 may also include the registered destination server computer returning the key code, registration ID and customer ID and a profile data request to the SSB server computer. Method 300 includes SSB server computer 250 processing the profile data request and checking to see if the user has specified any limitations on the user's profile data or limitations on the distribution to the particular destination server computer or its controlling entity, and the SSB server computer 250 sending the requested and approved profile data to the destination server computer using a distribution method. In a presently preferred embodiment, PE 208 on the SSB server computer 250 sends the requested and approved profile data. Also, in a presently preferred embodiment the preferred distribution method comprises distribution of a key code, a request back based on the key code, an approval process and distribution of relevant profile information via a HTTP Header Request.

SSB 202 may be configured to include a “site rating” feature that has a user input interface within a Web page delivered and controlled by an SSB server computer that accepts user input that effectively describes an embedded Web page from a destination server computer 112. Site rating data may be gathered to define the user who provided the input, thereby allowing that profile data to be applied to other profile-based uses such as a link preview or content filtering.

SSB 202 may be configured to include a “drill down search interface” within its MLGUI 204 that has a user input interface within a Web page delivered and controlled by an SSB server computer 250 that accepts user input to select search criteria. The drill down search interface searches strings as related to the particular search and then formats the search relevant to a user selected search source. The formatted search is then passed over the distributed network to the search source's destination server computer 112. Subsequent sources may then be searched merely by selecting the next source. The user can configure, order, delete and add various selection criteria and search sources as made available by the SSB 202 through the MLGUI 204.

SSB 202 may be configured to include an “anonymous or forwarding email address” utility embedded in the MLGUI 204 and/or the SSB server computer 250 such that a user may input an actual email address into a form element that resides in either a Web page or within the MLGUI 204 itself which will upon submission to the SSB 202 or the MLGUI 204 then convert the actual email address to an anonymous forwarding address using a random address generator or some other method. The conversion may be automated such that the user merely enters an actual email address into a static Web page 110 and upon submission the DMLRE 206 or some other component of the SSB 202 is able to read the address, recognize it is an address, perform the conversion and replace the submitted address with the forwarding address before sending the submission to the destination server computer 112. In yet another embodiment, the user must cut and paste the generated forwarding address from the MLGUI 204 into the form elements within a Web page and the SSB server computer 250 allows the pasted forwarding address to pass straight through to the destination server computer 112. An address registration process allows the SSB 202 and/or the MLGUI 204 to relate the original or actual address to the new forwarding address, both when it is created and when e-mail and files are inbound to the SSB 202 using the forwarding address.

In accordance with the anonymous or forwarding e-mail address utility, DMLRE 206 then rewrites all inbound email and/or email headers to remove the forwarding address and replace the same with the actual or original address. Optionally, DMLRE 206 may insert a message or a link to an email address management area on the SSB 202 or the MLGUI 204. SSB server computer 250 then sends the rewritten email on to the original address.

SSB 202 may be configured with an embedded email infrastructure where the user can send and receive email directly through the MLGUI 204. SSB 202 may be configured such that the MLGUI 204 allows the user to collect and manage stored Web page addresses or Web page bookmarks, by saving, renaming, deleting, organizing, sharing, searching and the like. SSB 202 may also be configured such that the MLGUI 204 and/or an SSB server computer 250 compile, store and utilize a historical list (a browsing history) of a user's requests from various destination server computers 112 within a distributed network. The user is also allowed to manage his historical list of Web page addresses visited by editing, deleting, organizing, saving, searching, recalling and/or the like. SSB 202 may also be configured such that the SSB 202 records and saves search sessions including search queries, destination server computer search source, Web page search results for a given query and all other relevant search data, allowing a user to recall the search session and resume or review later. The user is also allowed to manage the resulting search sessions by editing, deleting, naming, organizing and/or the like.

Although this invention has been described with reference to particular embodiments, the invention is not limited to these described embodiments. Rather, it should be understood that the embodiments described herein are merely exemplary and that a person skilled in the art may make many variations and modifications without departing from the spirit and scope of the invention. All such variations and modifications are intended to be included within the scope of the invention as defined in the appended claims.

What is claimed is:

1. A system for providing a user customized access to information distributed over a packet-based network, comprising:
a user computer including a client-side browser (CSB) configured for communication over said packet-based network;
a destination server computer configured for communication over said packet-based network, wherein said destination server computer contains said information; and
an intermediary server configured for communication over said packet-based network positioned between said user computer and said destination computer, wherein said intermediary server computer comprises a server-side browser (SSB) configured for filtering information transmitted between said user computer and said destination server computer in accordance with a user's preferences.

2. The system of claim 1, wherein said SSB comprises:
a markup language graphical user interface (MLGUI) using application utilities of said CSB for simulating functions and appearance of said CSB and further providing user access to server-side utilities not found in said CSB;
a profiling engine (PE) in communication with said MLGUI for gathering profile data including user demographics, surfing history, and habits from a user interacting with said SSB; and
a dynamic markup language rewriter engine (DMLRE) in communication with said MLGUI and said PE for dynamically analyzing, filtering, and rewriting said information transmitted between said user computer and said destination server computer in accordance with said profile data and said user's preferences.

3. The system of claim 2, wherein said application utilities of said CSB comprise parsers and interpreters located on said user computer.

4. The system of claim 2, wherein said server-side utilities comprises: data storage and static information delivery.

5. The system of claim 2, wherein said SSB further comprises a database configured for communication with said PE for storing said profile data.

6. The system of claim 5, wherein said user's preferences comprise value filters accessible by said PE and said DMLRE.

7. The system of claim 6, wherein said DMLRE receives content from said destination server computer, references said database and accesses said value filters, and rewrites said content in accordance with said value filters for display on said MLGUI.

8. A server-side browser (SSB) server computer configured for Internet connection for facilitating customized access to information distributed over a packet-based network, said SSB server computer comprising:
a bidirectional gateway between a user computer and destination server computer; and
a SSB controlling said bidirectional gateway, comprising:
a markup language graphical user interface (MLGUI) using application utilities of a client-side browser (CSB) installed on said user computer for simulating functions and appearance of said CSB and further providing user access to server-side utilities not found in said CSB;
a profiling engine (PE) in communication with said MLGUI for gathering profile data including user demographics, surfing history, and habits from a user interacting with said SSB; and
a dynamic markup language rewriter engine (DMLRE) in communication with said MLGUI and said PE for dynamically analyzing, filtering, and rewriting said information transmitted between said user computer and said destination server computer in accordance with said profile data and user's preferences.

9. The system of claim 8, wherein said SSB further comprises a database configured for communication with said PE for storing said profile data.

10. The system of claim 9, wherein said user's preferences comprise value filters accessible by said PE and said DMLRE.

11. The system of claim 10, wherein said DMLRE receives content from said destination server computer, references said database and accesses said value filters, and rewrites said content in accordance with said value filters for display on said MLGUI.

12. A server-side browser (SSB) for facilitating customized access to information distributed over a packet-based network, said SSB comprising:
a markup language graphical user interface (MLGUI) using application utilities of a client-side browser (CSB) installed on a user computer for simulating functions and appearance of said CSB and further providing user access to server-side utilities not found in said CSB;
a profiling engine (PE) in communication with said MLGUI for gathering profile data including user demographics, surfing history, and habits from a user interacting with said SSB; and
a dynamic markup language rewriter engine (DMLRE) in communication with said MLGUI and said PE for dynamically analyzing, filtering, and rewriting said information transmitted between said user computer and said destination server computer in accordance with said profile data and user's preferences.

13. The SSB of claim 12, further comprising a database configured for communication with said PE for storing said profile data.

14. The SSB of claim 12, wherein said rewriting comprises text language translation.

15. The SSB of claim 12, wherein said rewriting comprises Web page image removal.

16. The SSB of claim 12, wherein said rewriting comprises Web page image replacement.

17. A method for accessing customized information from an Internet, comprising:
logging into a server-side browser (SSB);
requesting information from a Web site on said Internet through said SSB;
said SSB receiving said requested information and rewriting said information from said Web site; and
displaying said rewritten information in said SSB.

18. The method of claim 17, further comprising providing anonymous or fictitious identification information to said Web site such that said Web site does not know a true identity of a user requesting said information.

19. A system for providing a user customized access to information distributed over a packet-based network, comprising:
a user computer hosting a client-side browser (CSB) for viewing markup language documents and multimedia files, executing applets and plug-in files distributed over said packet-based network;
a server-side browser (SSB) server computer configured to communicate with said user computer over said packet-based network, said SSB server computer hosting a SSB, said SSB comprising:
a combination of CSB application utilities from said user computer; and
server-side utilities from said SSB server computer; and
a destination server computer configured to communicate with said SSB server computer and hosting said information in the form of a Web page.

20. The system of claim 19, wherein said SSB further comprises an MLGUI for display on said CSB, wherein said CSB application utilities include parsers and interpreters located on said user computer.

21. The system of claim 19, wherein said SSB further comprises an MLGUI for display on said CSB, wherein said server-side utilities include buttons, menus and tools needed for interacting with said packet-based network are not provided by said CSB, but are provided within said MLGUI of said SSB.

22. The system of claim 19, wherein said SSB further comprises a dynamic markup language rewriter engine (DMLRE) located on the SSB server computer configured for:
receiving content including markup language, scripting code, applets, files and other data objects embedded within Web pages from said destination server connected to the network;
referencing a profile database and value filters on the SSB server computer;
rewriting said content in accordance with said referenced profile database and value filters; and
displaying said rewritten content within said MLGUI.

23. The system of claim 22, wherein said rewriting said content further comprises consulting a value filter (VF) for rules, libraries and data sets required by a particular value provided by said VF in accordance with said profile database.

24. The system of claim 22, wherein said rewriting said content further comprises filling in form elements within Web pages and submitting completed form elements on behalf of said user without user intervention or displaying same in said MLGUI.

25. The system of claim 19, wherein said SSB further comprises a profiling engine (PE) configured for:
displaying information gathering interfaces to a user using a Web page within said MLGUI;
said user inputting, directly or indirectly, profile data into said information gathering interfaces;
communicating said profile data to said SSB;
tracking an entire network browsing experience of said user as additional profile data; and
communicating such additional profile data to said SSB.

26. The system of claim 25, wherein said PE further comprises a database on said SSB server computer, wherein combined profile data, comprising said profile data and said additional profile data, may be recorded, stored, referenced, indexed and retrieved.

27. The system of claim 26, wherein said PE further comprises a database utility that separates and flags identifying data, or that data which would reveal the identity of or provide access to said user, within said combined profile data from descriptive data within said combined profile data.
